(19) United States
(12) Patent Application Publication
(10) Pub. No.: US 2012/0197434 A1
(43) Pub. Date: Aug. 2, 2012

(54) ROBOT CONTROL SYSTEM AND METHOD

(76) Inventors: Yueh-Sheng HO, Taipei City (TW); Wei-Pang LEE, Taipei City (TW)

(21) Appl. No.: 13/355,337

(22) Filed: Jan. 20, 2012

(30) Foreign Application Priority Data
Jan. 28, 2011 (TW) 100103429

(51) Int. Cl. B25J 9/18

(52) U.S. Cl. 700/245; 901/46; 901/1

(57) ABSTRACT

A robot control system includes a signal transmission device and a robot. The signal transmission device has two signal transmission elements that substantially transmit a first signal along a first direction and a second signal along a second direction respectively. The first signal defines a first signal area, and the second signal defines a second signal area. The overlap portion of the first and second signals defines a confinement area. The robot includes a detecting module and a control module. The detecting module detects the confinement area by detecting the first signal and the second signal simultaneously. When the detecting module detects the confinement area, the control module controls the robot to change direction and then move for a distance. Besides, a robot control method applied to the robot control system is also disclosed.

### CROSS REFERENCE TO RELATED APPLICATIONS

This Non-provisional application claims priority under 35 U.S.C. §119(a) on Patent Application No(s). 100103429 filed in Taiwan, Republic of China on Jan. 28, 2011, the entire contents of which are hereby incorporated by reference.

### BACKGROUND

1. Technical Field

The disclosure relates to a robot control system and method.

2. Related Art

Recently, several systems for controlling a robot to work within a specific space are disclosed. These systems are usually applied to mowing, cleaning, inspection, or transportation, which needs the robot to operate within a defined area. For example, if the control system is not well functioned to limit a clean robot to work in a first room, the clean robot may crawl to another room before finishing the cleaning of the first room. To solve this problem, a robot control system 1 is disclosed as shown in FIG. 1. The robot control system 1 includes a signal transmission device 11 and a movable robot 12. The signal transmission device 11 transmits a barrier signal S along a direction X, and the area covered by the barrier signal S is defined as a confinement area R. Once the robot 12 enters the confinement area R, it detects the barrier signal S and thus tries to escape from this area until no longer detecting the barrier signal S. If it is desired to restrict the robot 12 to move and work within a first area Z₁ and to prohibit the robot 12 to enter the second area Z₂, the signal transmission device 11 is usually installed at one end of the connection between the first area Z₁ and the second area Z₂, and has a signal transmission direction X towards the other end of the connection. For example, the connection may be a door between two rooms. Accordingly, the confinement area R separates the first area Z₁ and the second area Z₂, and thus forbid the robot 12 entering the second area Z₂ from the first area Z₁. The barrier signal S is, for example, an infrared ray with a specific frequency.

However, the signal transmission device 11 can not emit a totally linear light beam. In more details, the light beam near the signal transmission device 11 is concentrated, but it is diverged gradually after traveling for a distance. The diverged light beam has a sector-like shape as shown in FIG. 1. Since the light beam is diverged gradually, the barrier signal S becomes weaker as the distance increases, and this it is unrecognized then.

Therefore, when the robot 12 is located at the position farer away from the signal transmission device 11 (e.g. the position P₁ in FIG. 1) or the axis of the transmitted signal (e.g. the position P₂ in FIG. 1), the discontinuous signal detecting of the barrier signal S may easily occur, resulting in the misjudgment of the moving direction of the robot 12. If this misjudgment is happened, the robot 12 may cross the confinement area R and then enter the second area Z₂ from the first area Z₁. After entering the second area Z₂, the barrier signal S is not detected, so that the robot 12 determines that it is successfully escaped from the confinement area R and still stays in the first area Z₁. In this case, the function of the signal transmission device 11 for keeping the robot 12 to stay in a specific area is failed.

### SUMMARY

The disclosure is to provide a robot control system and method that define a more linear confinement area and provide a more complete and continuous signal within the confinement area, so that the misjudgment for determining whether the robot enters the confinement area can be reduced, and the robot entering the unexpected area caused by the bad signal and the corresponding misjudgment. Moreover, which side of the confinement area that the robot enters or leaves can be correctly determined, so that the case that the robot may leave from the wrong direction although the confinement area is detected can be prevented.

The embodiment of the present invention discloses a robot control system including a signal transmission device and a robot. The signal transmission device has two signal transmission elements, which substantially transmit a first signal along a first direction and a second signal along a second direction respectively. The first signal defines a first signal area, and the second signal defines a second signal area. An overlap portion of the first signal and the second signal defines a confinement area. The robot includes a detecting module and a control module. The detecting module detects the first signal and the second signal. When the detecting module detects the confinement area by detecting the first signal and the second signal simultaneously, the control module controls the robot to change direction and then move for a distance.

In one embodiment of the invention, the control module controls the robot to turn toward a reverse direction and then move for a distance, to rotate for a preset angle and then move for a distance, or to turn toward the weaker one of the first signal and the second signal and then move for a distance.

In one embodiment of the invention, after the robot has changed direction and then moved for a distance, the detecting module detects the first signal and the second signal again. For example, after the robot changes direction and then moves for a distance initiated as the detecting module detects the first signal originally and then detects both the first signal and the second signal later, and then the detecting module detects again to determine that only the second signal is detected, the control module controls the robot to move toward a reverse direction.

In one embodiment of the invention, when the detecting module detects the first signal or the second signal, the control module controls the robot to reduce a moving speed thereof.

In one embodiment of the invention, the first signal and the second signal are electromagnetic-wave signals with different frequencies, different wavelengths, different transmission sequence encodings, or different polarization directions.

In one embodiment of the invention, the first direction and the second direction are in parallel.

In one embodiment of the invention, the first direction and the second direction have an included angle smaller than a divergence angle of the first signal and the second signal.

In addition, the embodiment of the present invention also discloses a robot control method for a robot control system having a robot and a signal transmission device. The signal transmission device has two signal transmission elements, which substantially transmit a first signal along a first direction and a second signal along a second direction respectively. The robot control method includes the following steps of: detecting the first signal and the second signal; and controlling a robot to change direction and then move for a distance when detecting the first signal and the second signal simultaneously. Herein, the first signal defines a first signal area, the second signal defines a second signal area, and an overlap portion of the first signal and the second signal defines a confinement area.

In one embodiment of the invention, the step of controlling the robot to change direction and then move for a distance is to control the robot to turn toward a reverse direction and then move for a distance, to rotate for a preset angle and then move for a distance, or to turn toward the weaker one of the first signal and the second signal and then move for a distance.

In one embodiment of the invention, after the robot has changed direction and then moved for a distance, the robot control method further includes a step of detecting the first signal and the second signal again. Preferably, the robot control method further includes a step of: controlling the robot to move toward a reverse direction after the robot changes direction and then moves for a distance initiated as detecting the first signal originally and then detects both the first signal and the second signal later, and detecting again to determine that only the second signal is detected.

In one embodiment of the invention, the robot control method further includes a step of: controlling the robot to reduce a moving speed thereof when detecting the first signal or the second signal.

In one embodiment of the invention, the first signal and the second signal are electromagnetic-wave signals with different frequencies, different wavelengths, different transmission sequence encodings, or different polarization directions.

In one embodiment of the invention, the first direction and the second direction are in parallel.

In one embodiment of the invention, the first direction and the second direction have an included angle smaller than a divergence angle of the first signal and the second signal.

As mentioned above, the robot control system and method is to configure a signal transmission device for transmitting a first signal and a second signal, so that the robot detects the confinement area defined by the first and second signals and then leave the confinement area. When the robot enters or reaches the confinement area defined by the first and second signals, it performs an escape action. Thus, the robot can be limited to move only within a predetermined range. Compared with the prior art, there are two signal transmission elements configured in this invention, and they are partially overlapped to define the confinement area, so that the defined confinement area can be more linear. Moreover, the signal identification within the confinement area becomes better, more complete and more continuous, so that the misjudgment for determining whether the robot enters the confinement area and has to perform an escape action can be reduced. This can prevent the robot from passing through the confinement area due to the bad signal. Moreover, which side of the confinement area that the robot enters or leaves can be correctly determined, so that the case that the robot enters the unexpected area caused by the misjudgment can be prevented.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a robot control system;

FIG. 2 is a schematic diagram showing a robot control system according to a preferred embodiment of the invention;

FIG. 3 is a schematic diagram showing another aspect of the signal transmission device according to the preferred embodiment of the invention;

FIGS. 4A and 4B are schematic diagrams showing how the robot changes direction and moves for a distance according to the preferred embodiment of the invention;

FIG. 5 is a schematic diagram showing another aspect that how the robot changes direction and moves for a distance according to the preferred embodiment of the invention; and

FIG. 6 is a flow chart of a robot control method according to the preferred embodiment of the invention.

### DETAILED DESCRIPTION

FIG. 2 is a schematic diagram showing a robot control system CS according to a preferred embodiment of the invention. The robot control system CS includes a signal transmission device 30 and a robot 40. The signal transmission device 30 has two signal transmission elements, which substantially transmit a first signal S₁ along a first direction X₁ and a second signal S₂ along a second direction X₂ respectively. The area covered by the first signal S₁ is defined as a first signal area A, and the area covered by the second signal S₂ defines a second signal area B. An overlap portion of the first signal S₁ and the second signal S₂ (or the area covered by both the first signal S₁ and the second signal S₂) is defined as a confinement area R₁. In the confinement area R₁, the first signal S₁ and the second signal S₂ are both detected. To make the following description more clear, the two signal transmission elements of the signal transmission device 30 are defined as a first signal transmission element 31 and a second signal transmission element 32.

As shown in FIG. 2, if it is desired to restrict the robot 40 to move and work within a first area Z₁ and to prohibit the robot 40 to enter the second area Z₂, the signal transmission device 30 is installed at one end of the connection between the first area Z₁ and the second area Z₂, and two signal transmission directions X₁ and X₂ towards the other end of the connection are configured. For example, the connection may be a door between two rooms. Accordingly, the confinement area R₁ separates the first area Z₁ and the second area Z₂.

The robot 40 includes a detecting module 41 and a control module 42. The detecting module 41 detects the confinement area R₁ by detecting the first signal S₁ and the second signal S₂ simultaneously. When the detecting module 41 detects the confinement area R₁, the control module 42 controls the robot 40 to change direction and then move for a distance. Accordingly, the robot 40 leaves the confinement area R₁, and is forbid to pass the confinement area R₁ and enter the second area Z₂ from the first area Z₁.

In more detailed, the detecting module 41 includes at least one detecting element 411 for detecting the first signal S₁ and the second signal S₂. For example, the first signal S₁ and the second signal S₂ may be detected by a single detecting element 411 or by two detecting elements 411 respectively, as shown in FIG. 2. The detecting result is then transmitted to the control module 42. In this embodiment, the first signal S₁ and the second signal S₂ are electromagnetic-wave signals such as radio waves, microwaves, X-rays, or light signals, e.g. infrared light, visible light, or UV light. Besides, the first signal S₁ and the second signal S₂ may have different frequencies, different wavelengths, different transmission sequence encodings, or different polarization directions, so that the detecting module 41 can recognize the first signal S₁ and the second signal S₂ according to their frequencies, wavelengths, transmission sequence encodings, or polarization directions. To be noted, the transmission sequence of a signal is the output and non-output sequence of the signal transmission, and the sequence encoding is a specific output and non-output sequence within a certain time period. The output and non-output sequence in the signal can be converted into digital signals. Accordingly, the different transmission sequence encodings of the electromagnetic-wave signal contains different digital encodings, which is an excellent recognizing condition. In the following description, the first signal S₁ and the second signal S₂ include, for example, different transmission sequence encodings. If the detecting module 41 includes only one detecting element 411, it can determine whether the digital encoding of the detected signal represents either the first signal S₁ or the second signal S₂, or both the first signal S₁ and the second signal S₂ after the detecting element 411 detects the signal. It is also possible to detect the first signal S₁ and the second signal S₂ in turn within a short time period. Otherwise, if the detecting module 41 includes two detecting elements 411, they respectively detect the digital encodings of a specific signal, and then the detecting module 41 can output the detecting result to the control module 42 for the following operations according to that whether the two detecting elements 411 detect the first signal S₁ or the second signal S₂ or not.

In this embodiment, the first signal transmission element 31 outputs the first signal S₁, while the second signal transmission element 32 outputs the second signal S₂, and the first signal S₁ and the second signal S₂ are substantially in parallel. In other words, the first direction X₁ and the second direction X₂ are in parallel. The overlap area of the first signal S₁ and the second signal S2 defines the confinement area R₁. Alternatively, the signal transmission device 30 may have different aspects, which will be described hereinafter.

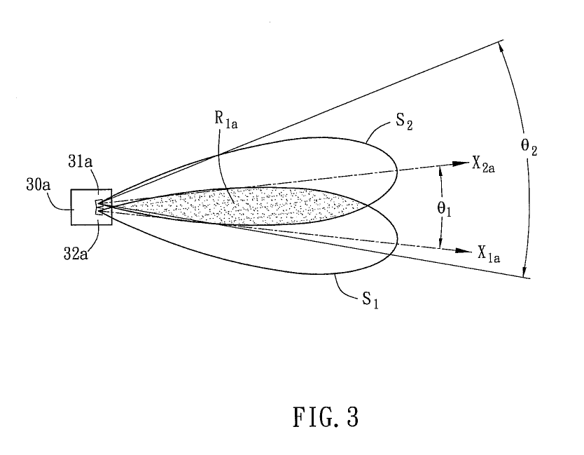

FIG. 3 is a schematic diagram showing another aspect of a signal transmission device 30a according to the preferred embodiment of the invention. Similar to the embodiment of FIG. 2, the signal transmission device 30a of FIG. 3 also includes a first signal transmission element 31a and a second signal transmission element 32a, which output the first signal S₁ along a first direction X₁ₐ and the second signal S₂ along a second direction X₂ₐ, respectively. In this embodiment, the confinement area R₁ₐ is also the area detected both the first signal S₁ and the second signal S₂ simultaneously. The difference between the signal transmission devices 30 and 30a is in that the first signal S₁ from the first signal transmission element 31a and the second signal S₂ from the second signal transmission element 32a have an included angle θ₁, so that the confinement area R₁ₐ can be more linear. To be noted, the included angle θ₁ must be adjusted corresponding to the property of the signal transmission elements, and it should be smaller than a divergence angle θ₂ of the first signal S₁ and the second signal S₂. In more specific, the range of the included angle θ₁ should be limited so that the first signal S₁ and the second signal S₂ are partially overlapped, and the overlap area is substantially linear.

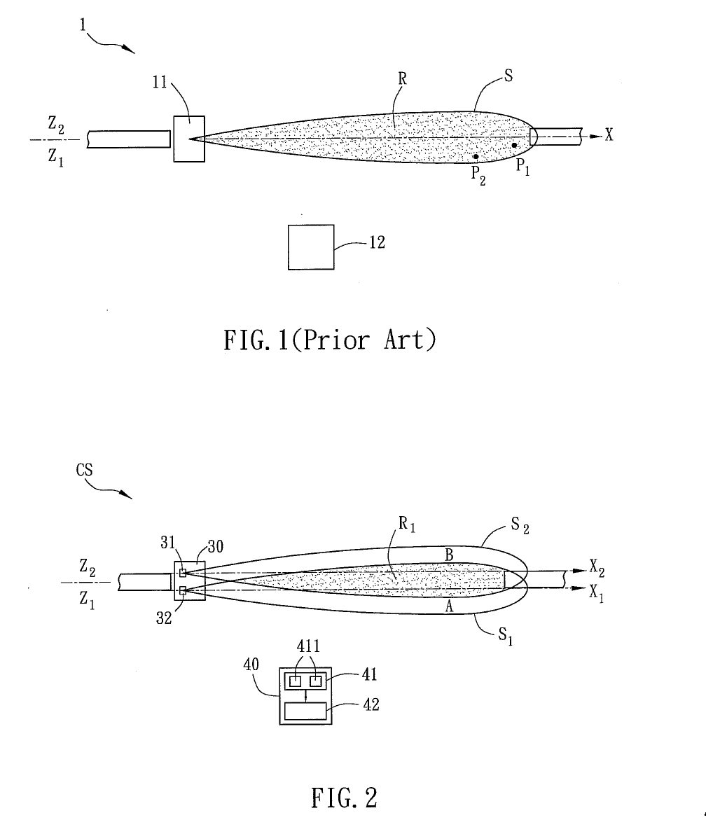

Since the first signal S₁ from the first signal transmission element 31a and the second signal S₂ from the second signal transmission element 32a have an included angle θ₁, some problems in the prior art can be overcome. The problems of the prior art are, for example, the serious signal decay and thus the discontinuous signal detecting at the position farer away from the signal transmission device 11 (e.g. the position P₁ in FIG. 1) or the axis X of the transmitted signal (e.g. the position P₂ in FIG. 1) within the confinement area R (see FIG. 1). As shown in FIG. 3, the confinement area R₁ₐ is either closer to the signal transmission device 30a or closer to the axis X₁ₐ or X₂ₐ, so that the signal transmitted in the confinement area R₁ₐ may maintain its intensity to prevent the undesired discontinuous signal detecting. Accordingly, the misjudgment while the robot 40 determines whether to change direction and move for a distance is avoided.

As mentioned above, the first signal S₁ and the second signal S₂ of this embodiment are radio waves, microwaves, X-rays, or light signals (e.g. infrared light, visible light, or UV light). Various signals may have different diverge or decay degrees. Besides, the first signal S₁ and the second signal S₂ may have different frequencies, different wavelengths, different transmission sequence encodings, or different polarization directions, so that the sector areas covered by the first signal S₁ and the second signal S₂ are different too. In practice, no matter the first signal S₁ and the second signal S₂ emitted from the signal transmission elements 31 and 32 or 31a and 32a are in parallel or have an included angle θ₁, the distance and/or included angle θ₁ between the two signal transmission elements 31 and 32 or 31a and 32a should be adjusted depending on the type of the used signal, thereby further increasing the linearity of the confinement area R₁ₐ.

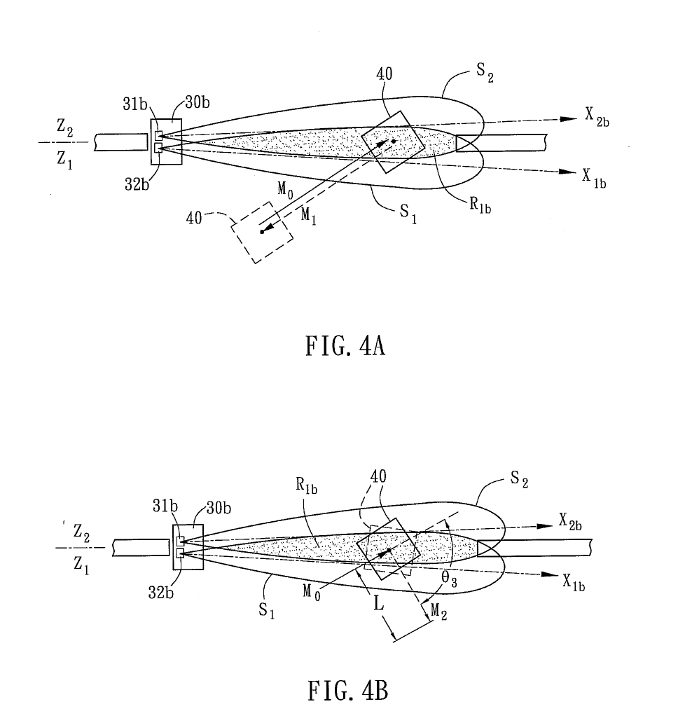

FIGS. 4A and 4B are schematic diagrams showing how the robot 40 changes direction and moves for a distance according to the preferred embodiment of the invention. With reference to FIGS. 2, 4A and 4B, the signal transmission device 30b of FIGS. 4A and 4B is mostly the same as the signal transmission device 30 of FIG. 2. The difference therebetween is in that the distance between the first signal transmission element 31b and the second signal transmission element 32b of FIGS. 4A and 4B is not equal to that between the first signal transmission element 31 and the second signal transmission element 32 of FIG. 2, and the first direction X_{1b} and the second direction X_{2b} are not in parallel. The adjustment allows the confinement area R_{1b} become more linear for separating the first area Z₁ and the second area Z₂. The robot 40 may change direction and move for a distance L so as to escape from the confinement area R_{1b}. For example, when the robot 40 is located in the first area Z₁ and moves along a direction M₀ to enter the confinement area R_{1b}, the detecting module 41 detect the first signal S₁ and the second signal S₂ simultaneously, thereby initiating the robot 40 to perform an escape action including to change direction and to move for a distance L. In the escape action, the robot 40 may be controlled to turn toward a reverse direction M₁ opposite to the original direction M₀ and then move for a distance L (see FIG. 4A), to rotate for a preset angle θ₃ and then move for a distance L (see FIG. 4B), or to turn toward the weaker one of the first signal S₁ and the second signal S₂ and then move for a distance L. The preset angle θ₃ is, for example but not limited to, 15 to 165 degrees. In the case of turning toward a reverse direction M₁ and then moving for a distance L, the robot 40 is controlled to rotate for 180 degrees and then move, or to go back to its original position.

To be noted, in the above embodiment, the robot 40 performs the escape action after entering the confinement area R_{1b}. However, it is also possible in other embodiments that the robot 40 can get the detecting result while it contact to, does not completely enter into, or does not contact to the confinement area R_{1b}, and the robot 40 can still perform the escape action according to the retrieved detecting result.

In order to make sure and correct the escape direction of the robot 40, the control module 41 may further control the detecting module 41 to detect the first signal S₁ and the second signal S₂ again after the robot 40 has changed direction and moved for a distance L, and then correct the moving route of the robot 40 after this new detecting result. This configuration prevents the misjudgment of the moving direction. The distance L may be, for example but not limited to, 10 to 100 centimeters.

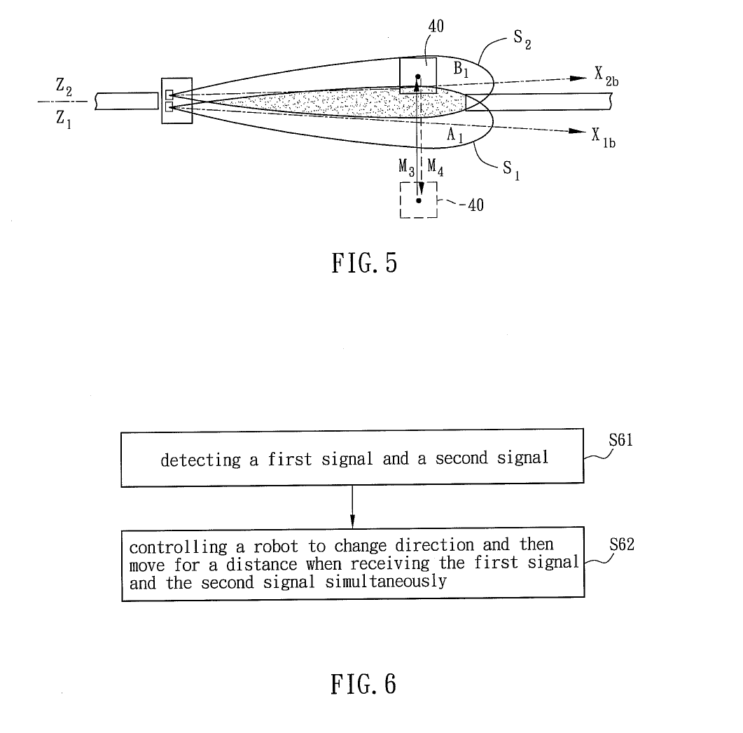

FIG. 5 is a schematic diagram showing another aspect that how the robot 40 changes direction and moves for a distance according to the preferred embodiment of the invention. Referring to FIG. 5, the configurations of FIG. 5 are mostly the same as that of FIG. 4A. The difference therebetween is in that the escape action of the robot 40 in FIG. 5 further involves a first signal area A₁ defined by the first signal S₁ transmitted substantially along the first direction X_{1b}. In FIG. 5, when the detecting module 41 detects the first signal area A₁ by detects the first signal S₁, the control module 42 controls the robot 40 to decrease its moving speed, thereby increasing the stability and accuracy for detecting signals. The robot 40 may define the first detected signal as the first signal S₁ or the second signal S₂; otherwise, it may define a signal with a specific transmission frequency, wavelength, transmission sequence encoding, or polarization direction as the first signal S₁ or the second signal S₂.

Besides, the escape action of the robot 40 may further include a debug process, which allows the robot 40 to detect the misjudgment in time and correct it. In details, if after the robot 40 changes direction and then moves for a distance initiated as detecting the first signal S₁ originally and then detects both the first signal S₁ and the second signal S₂ later, the detecting module 41 detects again to determine that only the second signal S₂ is detected, this means that the position (in the second signal area B₁) of the robot 40 and moving direction M₃ are wrong. Then, the control module 42 controls the robot 40 to move toward a reverse direction M₄ opposite to the original moving direction M₃. In this case, the first detected signal is defined as the first signal S₁, and the next detected signal is defined as the second signal S₂.

Of course, it is also possible to define in default two signals with specific transmission frequencies, wavelengths, transmission sequence encodings, or polarization directions as the first signal S₁ and the second signal S₁, respectively. In this embodiment, no matter what signal or signals are detected by the robot 40 before, once the detecting module 41 detects only the second signal S₂, the control module 42 controls the robot 40 to move toward a reverse direction M₄ opposite to the original moving direction M₃. This configuration ensures that incorrect moving do not grow too much if the misjudgment occurs.

FIG. 6 is a flow chart of a robot control method according to the preferred embodiment of the invention. The robot control method is applied to a signal transmission device. The signal transmission device has two signal transmission elements, which substantially transmit a first signal along a first direction and a second signal along a second direction respectively. The robot control method includes the following steps of: detecting the first signal and the second signal (step S61); and controlling a robot to change direction and then move for a distance when detecting the first signal and the second signal simultaneously (step S62). Herein, the first signal defines a first signal area, the second signal defines a second signal area, and an overlap portion of the first signal and the second signal defines a confinement area.

In addition, before the detecting module detects the confinement area, the robot control method may further include a step of: controlling the robot to reduce a moving speed thereof when detecting the first signal or the second signal, thereby increasing the stability and accuracy for detecting signals. Moreover, the robot control method further includes a step of controlling the robot to move toward a reverse direction after the robot changes direction and then moves for a distance initiated as detecting the first signal originally and then detects both the first signal and the second signal later, and detecting again to determine that only the second signal is detected. This step allows the robot to detect the misjudgment in time and correct it.

Since the robot control system applying the robot control method has the same features as that described in the previous embodiment, the detailed description will be omitted.

In summary, the robot control system and method is to configure a signal transmission device for transmitting a first signal and a second signal, so that the robot detects the confinement area defined by the first and second signals and then leave the confinement area. Preferably, when the robot enters or reaches the confinement area defined by the first and second signals, it performs an escape action. Thus, the robot can be limited to move only within a predetermined range. Compared with the prior art, there are two signal transmission elements configured in this invention, and they are partially overlapped to define the confinement area, so that the defined confinement area can be more linear. Moreover, the signal identification within the confinement area becomes better, more complete and more continuous, so that the misjudgment for determining whether the robot enters the confinement area and has to perform an escape action can be reduced. This can prevent the robot from passing through the confinement area due to the bad signal. Moreover, which side of the confinement area that the robot enters or leaves can be correctly determined, so that the case that the robot enters the unexpected area caused by the misjudgment can be prevented.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A robot control system, comprising:
a signal transmission device having two signal transmission elements, wherein the two signal transmission elements substantially transmit a first signal along a first direction and a second signal along a second direction respectively, the first signal defines a first signal area, the second signal defines a second signal area, and an overlap portion of the first signal and the second signal defines a confinement area; and
a robot comprising:
a detecting module detecting the first signal and the second signal; and
a control module controlling the robot to change direction and then move for a distance when the detecting module detects the confinement area by detecting the first signal and the second signal simultaneously.

2. The robot control system of claim 1, wherein the control module controls the robot:
to turn toward a reverse direction and then move for a distance;
to rotate for a preset angle and then move for a distance; or
to turn toward the weaker one of the first signal and the second signal and then move for a distance.

3. The robot control system of claim 1, wherein after the robot has changed direction and then moved for the distance, the detecting module detects the first signal and the second signal again.

4. The robot control system of claim 3, wherein after the robot changes direction and then moves for the distance initiated as the detecting module detects the first signal originally and then detects both the first signal and the second signal later, and the detecting module detects again to determine that only the second signal is detected, the control module controls the robot to move toward a reverse direction.

5. The robot control system of claim 1, wherein when the detecting module detects the first signal or the second signal, the control module controls the robot to reduce a moving speed thereof.

6. The robot control system of claim 1, wherein the first signal and the second signal are electromagnetic-wave signals with different frequencies, different wavelengths, different transmission sequence encodings, or different polarization directions.

7. The robot control system of claim 1, wherein the first direction and the second direction are in parallel.

8. The robot control system of claim 1, wherein the first direction and the second direction have an included angle smaller than a divergence angle of the first signal and the second signal.

9. A robot control method for a robot control system having a robot and a signal transmission device, the signal transmission device having two signal transmission elements, the two signal transmission elements substantially transmitting a first signal along a first direction and a second signal along a second direction respectively, the robot control method comprising steps of:
detecting the first signal and the second signal; and
controlling a robot to change direction and then move for a distance when detecting the first signal and the second signal simultaneously;
wherein, the first signal defines a first signal area, the second signal defines a second signal area, and an overlap portion of the first signal and the second signal defines a confinement area.

10. The robot control method of claim 9, wherein the step of controlling the robot to change direction and then move for the distance is to control the robot:
to turn toward a reverse direction and then move for a distance;
to rotate for a preset angle and then move for a distance; or
to turn toward the weaker one of the first signal and the second signal and then move for a distance.

11. The robot control method of claim 9, further comprising, after the robot has changed direction and then moved for the distance, a step of:
detecting the first signal and the second signal again.

12. The robot control method of claim 11, further comprising a step of:
after the robot changes direction and then moves for the distance initiated as detecting the first signal originally and then detects both the first signal and the second signal later, and detecting again to determine that only the second signal is detected, controlling the robot to move toward a reverse direction.

13. The robot control method of claim 9, further comprising a step of:
when detecting the first signal or the second signal, controlling the robot to reduce a moving speed thereof.

14. The robot control method of claim 9, wherein the first signal and the second signal are electromagnetic-wave signals with different frequencies, different wavelengths, different transmission sequence encodings, or different polarization directions.

15. The robot control method of claim 9, wherein the first direction and the second direction are in parallel.

16. The robot control method of claim 9, wherein the first direction and the second direction have an included angle smaller than a divergence angle of the first signal and the second signal.
